(19) United States
(12) Patent Application Publication
(10) Pub. No.: US 2020/0249769 A1
(43) Pub. Date: Aug. 6, 2020

(54) Touch Pen With NFC (Near Field Communication) Tag

(71) Applicant: E-Century Technical & Industrial Corporation, New Taipei City (TW)

(72) Inventor: I-Kuang Lai, New Taipei City (TW)

(73) Assignee: E-Century Technical & Industrial Corporation, New Taipei City (TW)

(21) Appl. No.: 16/358,698

(22) Filed: Mar. 20, 2019

(30) Foreign Application Priority Data
Jan. 31, 2019 (TW) 108201625

(51) Int. Cl. G06F 3/039; G06F 3/0354; H04B 5/00

(52) U.S. Cl. CPC G06F 3/039; H04B 5/0056; G06F 3/03545

(57) ABSTRACT

A touch pen with NFC (Near Field Communication) tag, with the touch pen consisting of: a pen body, a pen cap, a touch pen head, a pen clip, and a pen sleeve. A NFC identification tag is installed on the touch pen that allows a user to read using a smart mobile device that has a NFC read function, whereupon the smart mobile device displays webpage product information stored in the NFC identification tag, and enables direct linking to the relevant webpage corresponding to the product. The present invention not only provides basic functions of a touch pen but also applies NFC identification tag technology to write in a variety of product information for marketing use of the product. Moreover, the touch pen is further provided with an anti-counterfeiting function which extends the many basic functions of a conventional touch pen.

### CROSS REFERENCES TO RELATED APPLICATIONS

The present application claims priority from Taiwanese Patent Application Serial Number 108201625, filed Jan. 31, 2019 the disclosure of which is hereby incorporated by reference herein in its entirety.

### BACKGROUND OF THE INVENTION

### (a) Field of the Invention

The present invention relates to a touch pen, and more particularly to a touch pen with NFC tag.

### (b) Description of the Prior Art

The increasing development of society has brought about an increasing miscellaneous collection of product marketing methods, and numerous proprietors combine marketing methods with technology to achieve maximum effectiveness with less effort. Although mobile devices with touch control function commonly used by modern people (such as: smart cell phones, tablet computers) have been prevalent for a long time, which apart from using the finger as the operating method, a touch pen can also be used to provide better operating efficiency and improve accuracy, especially for editing graphics and for writing in which the touch pen is superior to finger operation.

Furthermore, with regard to product marketing methods, related product information is currently printed on the pen body of a touch pen for direct viewing by the user. However, such a method provides limited exposure of the product information, and, because it indirectly reveals obvious commercial information on the touch pen, results in a decrease in the design appeal of the entire touch pen.

Moreover, the willingness to use the touch pen is decreased because of the non-aesthetic quality of such a method, which correspondingly reduces the advertising effect of the product. In addition, even if there is a willingness to use this type of touch pen, however, contact with the touch pen over a long period of time causes wear and tear thereof, which results in the product information becoming blurred and indistinct, thereby further reducing product marketing effectiveness.

A detailed description of the distinctive characteristics and advantages of the present invention is provided in the following embodiments, the contents of which are sufficient for any persons skilled in the art to understand the technology involved and enablement thereof. Moreover, from the content disclosed in the specification, claims, and drawings, any persons skilled in the art can easily understand the related objects and advantages of the present invention.

### SUMMARY OF THE INVENTION

The main object of the present invention lies in: not only providing a touch pen with basic functions but also applying NFC (Near Field Communication) identification tag technology to write in a variety of product information for marketing use of the product, and further providing the touch pen with an anti-counterfeiting function. Accordingly, the present invention adds to the diversified application of the touch pen and extends the limited basic functions of a conventional touch pen

In order to achieve the aforementioned objects, the present invention provides a touch pen with NFC tag, comprising: at least one NFC identification tag installed on a touch pen.

According to one embodiment of the present invention, the touch pen comprises a pen body, a pen cap, a touch pen head, a pen clip, and a pen sleeve.

According to one embodiment of the present invention, the pen body is defined with a first installation area to enable installing the NFC identification tag.

According to one embodiment of the present invention, the pen cap is defined with a second installation area to enable installing the NFC identification tag.

According to one embodiment of the present invention, wherein the touch pen head is defined with a third installation area to enable installing the NFC identification tag.

According to one embodiment of the present invention.wherein the pen clip is defined with a fourth installation area to enable installing the NFC identification tag.

According to one embodiment of the present invention.wherein the pen sleeve is defined with a fifth installation area to enable installing the NFC identification tag.

According to one embodiment of the present invention, the touch pen head is installed at the front end of the pen body, and a connecting portion is formed at the end of the touch pen head that further connects to a replaceable touch control entry. A matching portion is formed on the upper portion of the touch control entry that connects to the connecting portion, and the lower portion of the touch control entry is defined with a touch control portion, which is installed with the NFC identification tag.

According to the embodiments of the present invention, the NFC identification tag enables writing in product information, product URL (Uniform Resource Locator) or related product data.

According to one embodiment of the present invention, the touch control entry further comprises an identification structure corresponding to the NFC identification tag installed in the touch pen.

Another object of the present invention lies in enabling the touch control entry and the touch pen head to be joined together by embedding the connecting portion into the matching portion, thereby allowing rotation and positioning the touch control entry at different angles, as well as achieving a replaceable configuration for the matching portion of the touch control entry.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a three-dimensional schematic view depicting application of a Near Field Communication (NFC) identification tag in a pen body according to the present invention.

FIG. 2 is a three-dimensional schematic view depicting application of the NFC identification tag in a pen cap according to the present invention.

FIG. 3 is a three-dimensional schematic view depicting application of the NFC identification tag in a touch pen head according to the present invention.

FIG. 4 is a three-dimensional schematic view depicting application of the NFC identification tag in a pen clip according to the present invention.

FIG. 5 is a three-dimensional schematic view depicting application of the NFC identification tag in a pen sleeve according to the present invention.

FIG. 6 is a three-dimensional schematic view depicting application of the NFC identification tag in a replaceable touch pen head according to the present invention.

FIG. 7 is a cross-sectional structural schematic view of a preferred embodiment of the present invention.

FIG. 8 is a schematic view depicting an operating state of the preferred embodiment of the present invention.

### DETAILED DESCRIPTION OF THE PREFERRED EMBODIMENTS

The following uses specific embodiments to describe implementable configurations of the present invention, and persons familiar with the art could easily understand other advantages and effects of the present invention from the content disclosed in the specification.

The structure, proportions, and sizes depicted in the drawings of the present specification are only for use in conjunction with the content disclosed in the present specification to provide an understanding and reference for persons familiar with the art, and are not used as limiting implementable conditions to limit the present invention, thus, have no substantial technical significance. Any structural modifications, proportional relationship changes, or size adjustments, without influencing the effectiveness produced by the present invention and the objects achieved by the present invention, should still equally fall within the range of the contents covered by the art disclosed in the present invention. Furthermore, terms such as “one”, “two”, and “upper” used in the present specification are only for the convenience of clarity in the description, and are not used as limiting implementable conditions to limit the present invention. Hence, changes or adjustments in corresponding relationships, without substantially changing the technical content, are regarded as within the implementable range of the present invention.

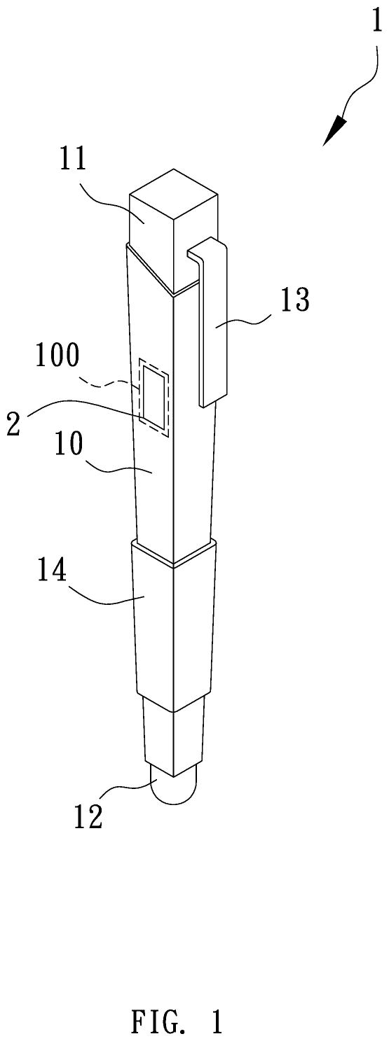

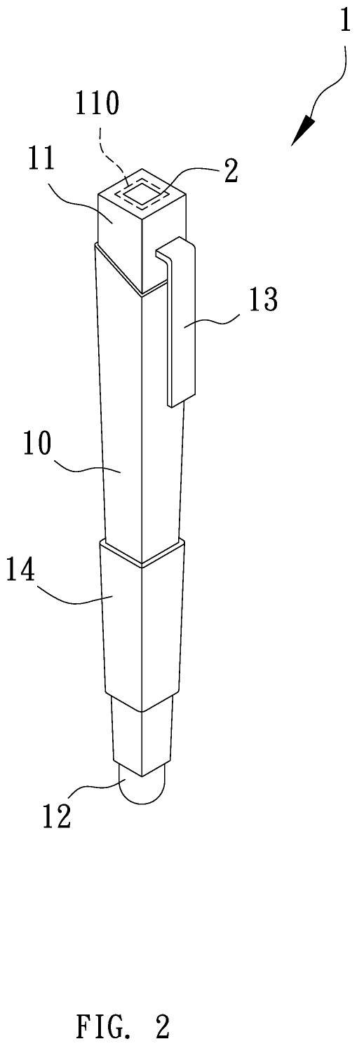

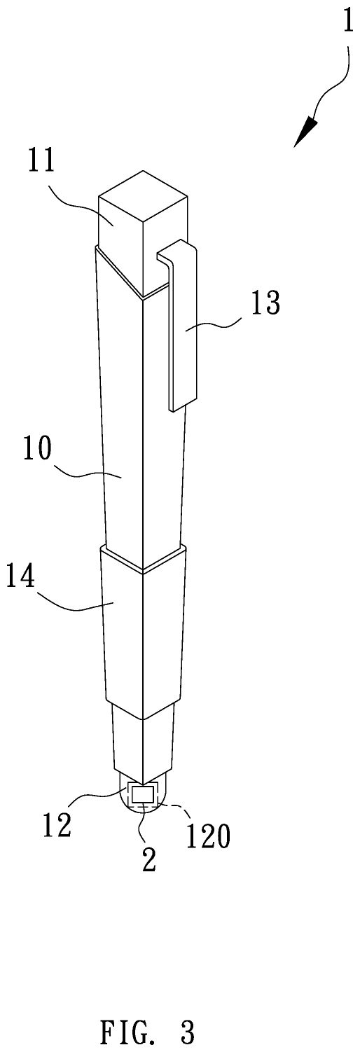

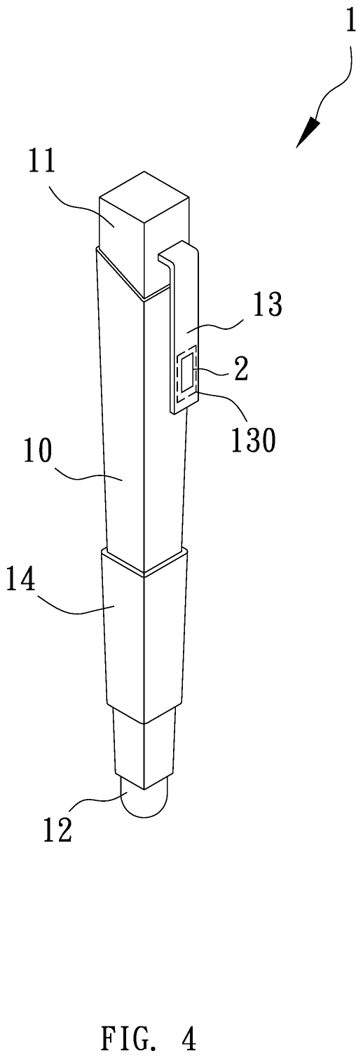

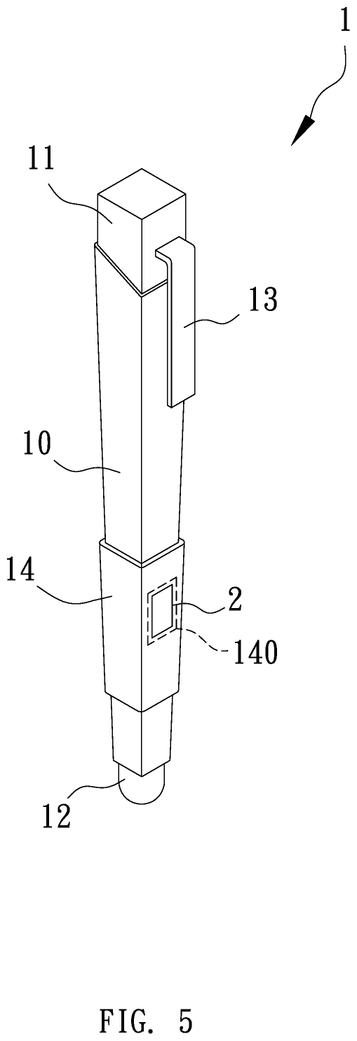

Referring to FIGS. 1 to 5, which show a three-dimensional schematic view depicting application of a Near Field Communication (NFC) identification tag 2 in a pen body 10, a three-dimensional schematic view depicting application of the NFC identification tag 2 in a pen cap 11, a three-dimensional schematic view depicting application of the NFC identification tag 2 in a touch pen head 12, a three-dimensional schematic view depicting application of the NFC identification tag 2 in a pen clip 13, and a three-dimensional schematic view depicting application of the NFC identification tag 2 in a pen sleeve 14, respectively according to the present invention, wherein a touch pen with NFC identification tag of the present invention comprises a touch pen 1 mainly structured from: the pen body 10, the pen cap 11, the touch pen head 12, the pen clip 13, and the pen sleeve 14, and at least one NFC identification tag 2 is installed at any optional position on the touch pen 1. Referring to the FIGS. 1 to 5 for actual installation positions of the NFC identification tag 2, wherein the pen body 10 in FIG. 1 is defined with a first installation area 100 with the NFC identification tag 2 installed thereat. The pen cap 11 in FIG. 2 is defined with a second installation area 110 with the NFC identification tag 2 installed thereat. The touch pen head 12 in FIG. 3 is defined with a third installation area 120 with the NFC identification tag 2 installed thereat. The pen clip 13 in FIG. 4 is defined with a fourth installation area 130 with the NFC identification tag 2 installed thereat. And the pen sleeve 14 in FIG. 5 is defined with a fifth installation area 140 with the NFC identification tag 2 installed thereat. From the aforementioned description it can be understood that the touch pen 1 not only provides basic functions of a touch pen but can also apply the technology of the NFC identification tag 2 to write in a variety of product information to use for marketing purposes. Moreover, the NFC identification tag 2 provides an anti-counterfeiting function, adding to the diversified application of the touch pen 1 of the present invention and extending the limited basic functions of a conventional touch pen.

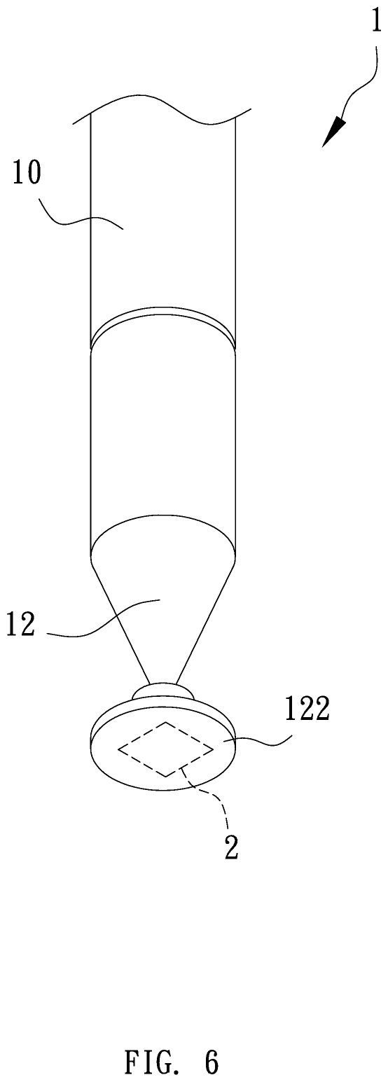

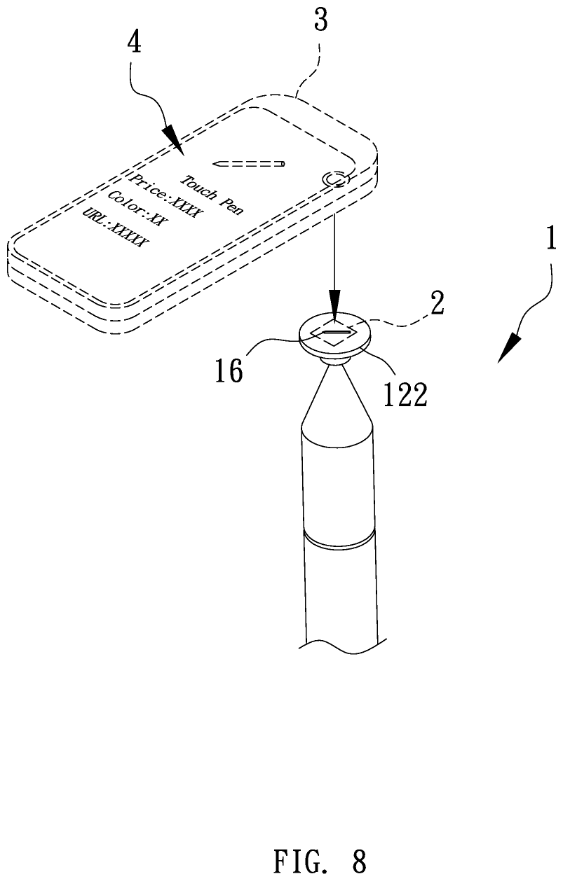

Referring together to FIGS. 6 to 8, which show a three-dimensional schematic view, a cross-sectional structural schematic view, and a schematic view depicting an operating state, respectively, depicting application of the NFC identification tag 2 in a replaceable touch pen head according to the present invention, wherein the touch pen 1 of the present embodiment comprises the touch pen head 12 (a transparent touch pen head), the pen body 10, and a replaceable touch control entry 122. The touch pen head 12 is installed on the front end of the pen body 10 and forms a connecting portion 121 and the replaceable touch control entry 122; moreover, a matching portion 124 that connects to the third installation area 120 is formed on the upper portion of the touch control entry 122. The lower portion of the touch control entry 122 is defined with a touch control portion 126 that is installed with the NFC identification tag 2.

An identification structure 16 (not shown in FIGS. 1-6) is further positioned in the touch control portion 126 and covers the NFC identification tag 2. The identification structure 16 is set up with a configuration corresponding to the NFC identification tag 2.

The NFC identification tag 2 enables writing in product information, such as product URL (Uniform Resource Locator) or related product data.

The NFC identification tag 2 of the touch pen 1 of the present invention is used to first write in product information, the user then opens the NFC read function in the smart mobile device 3 and holds the smart mobile device close to the NFC identification tag 2, whereupon the smart mobile device 3 displays product information 4 stored in the NFC identification tag 2. From the aforementioned description it can be understood that the NFC identification tag 2 in the present invention enables a merchant to write in product information, product URL, or related product information, and can then install the NFC identification tag 2 in the commonly used touch pen 1. In addition, the identification structure 16 enables the user to know at a glance where the touch pen 1 is installed with the NFC identification tag 2, whereupon the user can proceed with reading the NFC identification tag 2 following the above-described steps.

First, the user is able to read the NFC identification tag 2 through the smart mobile device 3 that has a NFC read function, whereupon the smart mobile device 3 displays product information stored in the NFC identification tag 2 and enables directly linking to the relevant webpage corresponding to the product. Accordingly, the present invention not only provides the basic functions of a touch pen, but is also further able to apply the technology of the NFC identification tag 2 to write in a variety of product information for marketing use of the product. Furthermore, the present invention has an anti-counterfeiting application adding to the diversified application of the present invention ant not limiting the touch pen 1 to known basic functions.

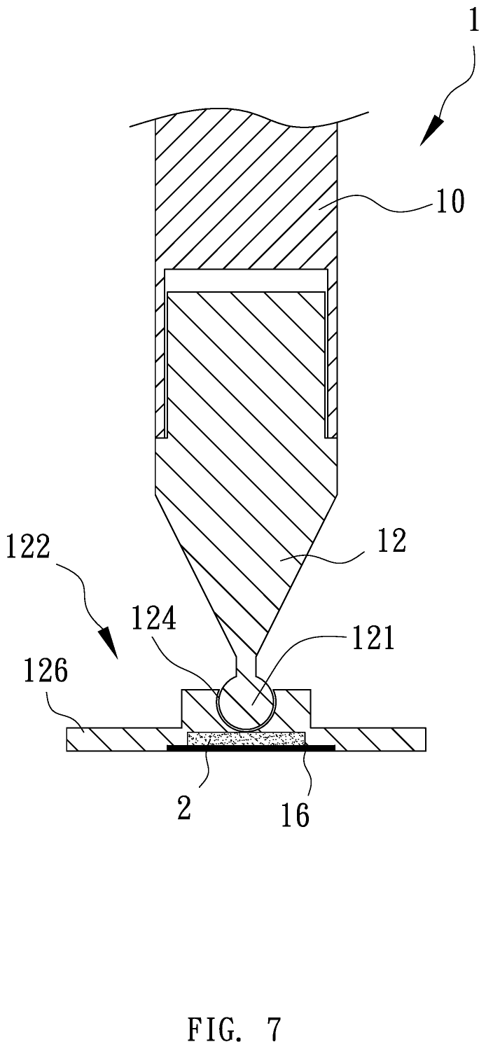

Apart from achieving the above described objects, from FIG. 7 it can be clearly understood that the touch control entry 122 and the touch pen head 12 are joined together by embedding the connecting portion 121 into the matching portion 124, enabling rotation and positioning at different angles thereof, as well as achieving a replaceable configuration for the matching portion 124 of the touch control entry 122.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A touch pen with NFC (Near Field Communication) tag, comprising:
a pen body, a pen cap, a touch pen head, a pen clip, and a pen sleeve;
moreover, NFC identification tags are installed on the touch pen.

2. The touch pen with NFC tag according to claim 1, wherein the pen body is defined with a first installation area to enable installing the NFC identification tag thereon.

3. The touch pen with NFC tag according to claim 1, wherein the pen cap is defined with a second installation area to enable installing the NFC identification tag thereon.

4. The touch pen with NFC tag according to claim 1, wherein the touch pen head is defined with a third installation area to enable installing the NFC identification tag thereon.

5. The touch pen with NFC tag according to claim 1, wherein the pen clip is defined with a fourth installation area to enable installing the NFC identification tag thereon.

6. The touch pen with NFC tag according to claim 1, wherein the pen sleeve is defined with a fifth installation area to enable installing the NFC identification tag thereon.

7. The touch pen with NFC tag according to claim 1, wherein the touch pen head is installed on a front end of the pen body, and the touch pen head forms a connecting portion and a replaceable touch control entry, an upper portion of which forms a matching portion that connects to the connecting portion, and a lower portion of the touch control entry defines a touch control portion that is installed with the NFC identification tag.

8. The touch pen with NFC tag according to claim 1, wherein the NFC identification tag enables writing in product information, product URL (Uniform Resource Locator) or related product data.

9. The touch pen with NFC tag according to claim 1, wherein the touch pen further comprises an identification structure installed thereon corresponding to the NFC identification tag.
